(19) United States
(12) Patent Application Publication
(10) Pub. No.: US 2007/0117958 A1
(43) Pub. Date: May 24, 2007

(54) Method for producing a polymer system capable of proton exchange, based on polyaryl ether ketones

(75) Inventors: Helmut Mohwald, Annweiler (DE); Andreas Fischer, Mannheim (DE); Klaus Frambach, Hassloch (DE); Ingolf Hennig, Neulussheim (DE); Sven Thate, Neuleiningen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/545,084

(22) PCT Filed: Feb. 27, 2004
(86) PCT No.: PCT/EP04/01975

§ 371 Date: Aug. 9, 2005

(30) Foreign Application Priority Data
Feb. 28, 2003 (DE) 103 09 135.1

(51) Int. Cl. C08G 16/00

(52) U.S. Cl. 528/220

(57) ABSTRACT

A method of preparing a polymer system which is capable of proton-exchange on the basis of at least one polyaryletherketone, comprising the step (i): (i) Reacting the at least one polyaryletherketone with at least one alkanesulfonic acid to obtain sulfur-containing polyaryletherketones (I), and sulfonated polyaryletherketones which can be prepared via the method according to the invention and their use as a polymer electrolyte membrane.

The present invention relates to a method of preparing sulfonated polyaryletherketones, sulfur-containing polyaryletherketones which can be prepared by a reaction involving at least one alkanesulfonic acid, sulfonated polyaryletherketones which can be prepared by reacting the sulfur-containing polyaryletherketones, cross-linked sulfonated polyaryletherketones, polymer blends comprising the sulfonated polyaryletherketones, polymer electrolyte membranes comprising the sulfonated polyaryletherketones, a fuel cell comprising at least one polymer electrolyte membrane according to the invention, and generally to the use of alkanesulfonic acids for treating polyaryletherketones.

Polyaryletherketones and the use thereof are known in the prior art. For example use is made, in fuel cell technology, of polyetheretherketones from the group consisting of the polyaryletherketones as or in polymer electrolyte membranes. In this context, said polyetheretherketones are functionalized so as to be ion exchange-enabled, and in that case preferably enabled to take up and give off protons. Functional groups to be mentioned in this context are, in particular, the —COOH— and —SO₃H— groups.

Examples of sulfonating reagents for polyaryletherketones described in the prior art are oleum, concentrated sulfonic acid or sulfur trioxide in a suitable organic solvent. Also known is lithiation by means of butyllithium, reaction with sulfur dioxide, followed by oxidation with, for example, potassium permanganate.

DE 100 47 551 A1 discloses the use of sulfonated polyetheretherketones as proton-exchanging membranes, the use of the membranes being described as preferred in direct methanol fuel cells. Here, sulfonation of the polyetheretherketone is effected using sulfur trioxide, sulfuric acid or trimethylsilylsulfonyl chloride.

EP 574 791 A2 describes the sulfonation of polyaryletherketones by means of sulfonic acid. The sulfonated polymer is used, inter alia, as an electrolyte membrane in fuel cells.

The sulfonation of polymers other than polyaryletherketones and the use as proton-exchanging membranes is described, for example, by JP 2002025580 A2. According to this publication, Nafion® is functionalized by means of gas-phase sulfonation.

The sulfonation of films, which in turn are prepared from heat-resistant polymers containing imide bonds and which are used as ion exchange membranes in fuel cells, for example, is described by JP 2001233974 A2. Here, sulfonation is achieved by immersing the film into sulfuric acid.

The use of alkanesulfonic acids such as, e.g. methanesulfonic acid, in electrolyte membranes employed in fuel cells is described, for example by JP 2001325970 A2. Described there is the procedure, for the purpose of fabricating the membranes, of impregnating a previously sulfonated polymer matrix with methanesulfonic acid, phosphoric acid or sulfuric acid, which act as the liquid electrolyte.

JP 2000294033 A2 discloses the fabrication of proton-conducting DNA membranes which can be used in fuel cells, DNA membranes being immersed in polar organic solvents containing strong acids such as methanesulfonic acid, ethanesulfonic acid, phosphoric acid or sulfuric acid. As a result of said immersion, the DNA membrane is loaded with the strong acid.

Using these polymer sulfonation methods known from the prior art, it is extremely difficult or even impossible for the degrees of sulfonation to be regulated exactly, in particular for low degrees of sulfonation to be standardized exactly in the case of polyetheretherketones.

DE-A 101 16 391 discloses sulfonated amorphous polyetherketonketones (s PEKK). Sulfonation is carried out using diphenyl ether and benzene dicarboxylic acid derivative, preferably benzene dicarboxylic acid dichloride.

According to DE-A 101 16 391, the degree of sulfonation of the amorphous polyetherketonketones used can be standardized.

The term “low degrees of sulfonation” is to be understood, within the scope of the present invention, as degrees of sulfonation below 60% and, in particular, below or equal to 55%. The term “degree of sulfonation”, within the scope of the present invention, relates to the number of sulfonic acid groups, calculated from the sulfur content determined by means of elemental analysis, per repeating unit of the polyaryletherketone. A “degree of sulfonation” of 100% in this context designates a sulfur-containing polyaryletherketone which, on statistical average, has one “sulfonic acid group” per repeating unit.

Exact standardization of the “degree of sulfonation” means standardization which in general deviates by at most +/−5%, preferably at most by +/−2% from the desired degree of sulfonation.

It is an object of the present invention to provide a method which allows degrees of sulfonation to be systematically standardized over a wide range, for example in the range of from 10 to 90%, and for example, preferably allows even low degrees of sulfonation to be specifically standardized while keeping constant simple parameters such as temperature, reaction time and sulfonating reagent concentration.

Systematic standardization of the degree of sulfonation of polyaryletherketones is important, since polyaryletherketones having a very high degree of sulfonation are water-soluble and polyaryletherketones having a very low degree of sulfonation are poor ion conductors. For a preferred use as membranes in fuel cells it is desirable, however, to provide water-insoluble, yet highly ion-conductive polyaryletherketones. These can be obtained by means of a systematically standardized degree of sulfonation.

This object was achieved by means of a method which, in contrast to the methods known in the prior art, involves the reaction, in a step (i), of a polyaryletherketone with at least one alkanesulfonic acid.

Accordingly, the present invention relates to a method of preparing sulfonated polyaryletherketones, comprising the step (i):
(i) Reacting the at least one polyaryletherketone with at least one alkanesulfonic acid to obtain sulfur-containing polyaryletherketones (I).
   Step (i):

If two or more different polyaryletherketones are used together in the method according to the invention it is conceivable for only one of the polyaryletherketones to be sulfonated. Equally, two or more can be sulfonated.

The polyaryletherketones which can be used in principle are all those which are liable to be sulfonated by means of alkanesulfonic acids. Suitable polyaryletherketones are the polyaryletherketones of formula I mentioned in EP-A 0 574 791, and polyaryletherketones of formulae IV, V and VI used preferably in EP-A 0 574 791.

The preferred polyaryletherketones used in the context of the present invention are polyetheretherketones, polyetherketones, polyetherketonketones. Suitable compounds from these groups are known to those skilled in the art. Also preferred are polyetheretherketones and polyetherketones. Particular preference is given to the use of the PEEK™ and PEK™ polymer types (available from Victrex plc.), especially PEEK™ 450P, PEEK™ 150P and PEK™ P22.

Generally suitable as the alkanesulfonic acid in step (i) are aliphatic sulfonic acids. Preferentially employed are alkanesulfonic acids of the general formula
R—SO₃H

Here, R is a hydrocarbon radical which can be branched or unbranched, having from 1 to 12 carbon atoms, preferably having from 1 to 6 carbon atoms, particularly preferably being an unbranched hydrocarbon radical having from 1 to 3 carbon atoms, especially preferably having 1 carbon atom, i.e. methanesulfonic acid.

Accordingly, the present invention also relates to a method as described above, wherein the alkanesulfonic acid is methanesulfonic acid and the at least one polyaryletherketone is a polyetheretherketone.

The solvent used is in general at least one alkanesulfonic acid or a mixture of different alkanesulfonic acids. Preference is given to the use of the alkanesulfonic acid employed in step (i) for the reaction with the polyaryletherketone, particular preference to the use of methane sulfonic acid. This means that the at least one alkanesulfonic acid itself preferably acts as the solvent. Suitable alkanesulfonic acids are mentioned above.

The at least one polyaryletherketone can be introduced into the reaction in any suitable form. Preferably, the polyetheretherketone is used as a powder. If the step (i) is to be carried out in one or more solvents, the polyaryletherketone can, prior to the reaction with the at least one alkanesulfonic acid, be dissolved or suspended in at least one alkanesulfonic acid and be reacted with the at least one alkanesulfonic acid.

Preferably, the reaction according to (i) is carried out at temperatures in the range of from 15 to 120° C., more preferably in the range of from 15 to 90° C., most preferably in the range of from 25 to 70° C., and especially preferably in the range of from 30 to 50° C. In principle it is conceivable, in this context, for the temperature to be kept constant during the reaction or to be altered continuously or in discrete steps. Preferably, the temperature is kept constant during the reaction.

The reaction according to (i) is preferably carried out over a period in the range of from 1 to 25 h, more preferably in the range of from 2 to 20 h and especially preferably over a period of from 4 to 16 h.

Accordingly, the present invention also relates to a method as described above, wherein the reaction according to (i) is carried out at temperatures in the range of from 15 to 120° C., preferably in the range of from 15 to 90° C. over a period of from 2 to 20 hours.

The reaction according to (i) will preferably be carried out under atmospheric pressure. Equally it is conceivable, in principle, for a pressure other than atmospheric pressure to be set during the reaction. During the reaction the pressure can be kept constant, or it can change continuously or discretely.

The molar ratio of the reaction partner according to (i) can essentially be chosen as desired. For the reaction according to (i), a molar ratio chosen of polyaryletherketone to be sulfonated to alkanesulfonic acid will be in the range of, in general, from 1:1 to 1:1000, preferably from 1:2 to 1:500 and particularly preferably from 1:10 to 1:300. In general, the at least one alkanesulfonic acid is employed in excess.

If the alkanesulfonic acid is at the same time used as the solvent, it is present in molar excess relative to the polyaryletherketone.

In a particularly preferred embodiment, the reaction in step (i) is carried out in such a way that the alkanesulfonic acid preferably used as the solvent at the same time is admixed in a reactor, with stirring, with the polyaryletherketone. Stirring is continued for the above mentioned period at the above mentioned reaction conditions. The sulfur-containing polyaryletherketone formed can be isolated via methods known to those skilled in the art. In a preferred embodiment of the method according to the invention, however, the sulfur-containing polyaryletherketone is not isolated, but is reacted with at least one further sulfonating agent to obtain sulfonated polyaryletherketones (II) in a further procedural step (ii), with the options of carrying out the procedural step (ii) in a reactor different from that for the procedural step (i), or—preferably—in the same reactor as procedural step (i).

The present invention further relates to a sulfur-containing polyaryletherketone which can be prepared via a method as described above.

A “sulfur-containing polyaryletherketone” in this context is to be understood as a polyaryletherketone which contains bound sulfur. The latter need not, or not exclusively, be present in the form of sulfonic acid groups.

The sulfur content of the sulfur-containing polyaryletherketones, preferably of the PEEK™ and PEK™ polymer types (available from Victrex plc.) is generally from 0.10 to 8.7 wt %, preferably from 4 to 5.7 wt %, determined by elemental analysis.

In a preferred embodiment of the method according to the invention, the step (i) is followed by a sulfonation step (ii) in which the degree of sulfonation of the sulfur-containing polyaryletherketones obtained according to (i) is standardized.

If the sulfur-containing polyaryletherketone prepared in accordance with (i) is produced in the alkanesulfonic acid optionally used as the solvent, the solution obtained in accordance with (i) can be used directly in (ii). Equally, a solvent exchange is conceivable. In a preferred embodiment, according to which a solution of the at least one polyaryletherketone in the at least one alkanesulfonic acid is obtained from (i), this solution is used directly in (ii).

While it is possible, in principle, for the sulfur-containing polyaryletherketone obtained from (i) to be reacted in accordance with (ii) one or more times with at least one alkanesulfonic acid as the sulfonating agent, particular preference is given, within the scope of the present invention, to the use, in (ii), of at least one sulfonating agent which differs from alkanesulfonic acids. In this context, any sulfonating agent known in the prior art and described by way of example above can, in principle, be used, such as, inter alia, oleum, concentrated sulfuric acid, highly concentrated (i.e. 98% strength) sulfuric acid, sulfur trioxide or chlorosulfonic acid in at least one suitable organic solvent, or butyllithium together with sulfur dioxide with subsequent oxidation by means of, for example, potassium permanganate.

Accordingly, the present invention relates to a method as described above, which comprises the additional step (ii):
(ii) Reacting the sulfur-containing polyaryletherketones obtained according to (i) with at least one sulfonating agent to obtain sulfonated polyaryletherketones (II).
   Step (ii):

The present invention thus describes a method in which a polyaryletherketone and preferably a polyetheretherketone is sulfur-functionalized and sulfonated in at least two steps, where the treatment with alkanesulfonic acid can be seen as a pretreatment step, which is followed by a sulfonation step by means of which the polyaryletherketone degree of sulfonation ultimately aimed for is achieved.

As has already been described above, the solution preferably obtained in accordance with (i) is preferably used directly in (ii). In a particularly preferred embodiment, this solution is, in accordance with (ii), brought into contact with oleum having an SO₃ content of 25% or highly concentrated (98% strength) sulfuric acid as the sulfonating agent.

Accordingly, the present invention also relates to a method as described above, wherein the at least one sulfonating agent used is oleum.

The reaction parameters of step (ii) can be adjusted depending on the “degree of sulfonation” to be achieved in accordance with (ii).

A particular advantage of the method described within the scope of the present invention can be seen in the fact that after the pretreatment by means of alkanesulfonic acid has been carried out in accordance with (i), setting those reaction parameters that can be adjusted relatively easily, such as temperature, reaction time and concentration of the sulfonating agent, preferably oleum and highly concentrated (98% strength) sulfuric acid, the “degree of sulfonation” of the sulfonated polyaryletherketones can be standardized reproducibly over a wide range, particularly in a range of from 10 to 90%. The different “degrees of sulfonation” of the polyaryletherketones are controlled in particular via the concentration of the sulfonating agent.

The method according to the invention thus permits rapid sulfonation of polyaryletherketones, achieving a narrow distribution of the “degree of sulfonation”.

Using the method according to the invention, comprising the steps (i) and (ii), it is possible to obtain sulfonated polyaryletherketones which have a “degree of sulfonation” in the range of from 10 to 90%. More preferably, polyaryletherketones are obtained which have a “degree of sulfonation” in the range of from 35 to 80%.

Particularly preferably, the method according to the invention, comprising the steps (i) and (ii) prepares sulfonated polyaryletherketones having low “degrees of sulfonation”, particularly preferably having “degrees of sulfonation” of, in general, from 10 to 55%, preferably from 35 to 55%, particularly preferably from 48 to 55% or from 35 to 40%.

In principle it is conceivable for the temperature to be kept constant during the reaction or to be altered continuously or in discrete steps. Preferably, the temperature is kept constant during the reaction, the sulfonation in accordance with (ii) preferably being carried out under atmospheric pressure. If, for example, a sulfonated polyaryletherketone having “degrees of sulfonation” of from 10 to 60%, preferably from 35 to 60%, particularly preferably from 48 to 55% or from 35 to 40% is to be obtained in accordance with (ii), the sulfonating agent used, generally highly concentrated (98% strength) sulfuric acid, is in this case preferably used in a weight ratio, based on the sulfur-containing polyaryletherketone obtained in accordance with (i), in the range of from 2 to 10 and particularly preferably from 6 to 10, especially preferably from 8 to 9.

The present invention therefore also relates to sulfonated polyaryletherketones, preferably sulfonated polyetheretherketones, which can be prepared via the method according to the invention comprising the steps (i) and (ii). Preferred embodiments of the method according to the invention are mentioned above.

The sulfonated polyaryletherketones, preferably sulfonated polyetheretherketones, according to the present invention show a polydispersity M_{w}/Mₙ in general of from <3, preferably <2.9, more preferably of from <2.6. M_{w} is the weight average molecular weight and Mₙ is the number average molecular weight. M_{w} and Mₙ are determined by size exclusion chromatography (SEC).

Further, the polyaryletherketones of the present invention show a reduced swelling in water.

Further, the sulfonated polyaryletherketones, preferably sulfonated polyetheretherketones, according to the present invention are characterized by an outstanding stability versus methanol of membranes comprising the sulfonated polyaryletherketones. The sulfonated polyaryletherketones according to the present invention are therefore especially useful in methanol fuel cells.

It is generally preferred for the sulfonated polyaryletherketone obtained in accordance with (ii) to be obtained in solution, particularly preferably in the at least one alkanesulfonic acid used in step (i), it being conceivable, in principle, for the sulfonated polyaryletherketone to be employed in solution, depending on its area of application. Equally, a solvent exchange via a suitable technique is conceivable. Equally, the sulfonated polyaryletherketone can be isolated from the solution via a suitable technique known to those skilled in the art and be used in its area of application. Preferably, the isolation of the sulfonated polyaryletherketone is effected from the preferentially obtained solution of the at least one alkanesulfonic acid employed in step (i) by precipitation in ice water, washing and drying, the sulfonated polyaryletherketone generally being obtained in the form of a powder, granules or fibers, depending on the isolation step.

In a further embodiment of the process according to the present invention the isolation of the sulfonated polyaryletherketone, preferably sulfonated polyetheretherketone, from the solution of the alkane sulfonic acid used in step (i), which is preferably obtained, is carried out by a two-step treatment.

The present invention therefore further relates to a process for preparing sulfonated polyaryletherketones comprising steps (i) and (ii):
(i) Reacting the at least one polyaryletherketone with at least one alkanesulfonic acid to obtain sulfur-containing polyaryletherketones (I);
(ii) Reacting the sulfur-containing polyaryletherketones obtained according to (i) with at least one sulfonating agent to obtain sulfonated polyaryletherketones (II),
   wherein the sulfonated polyaryletherketones (II) are obtained in solution and are isolated from the solution by a two-step treatment comprising steps (iii) and (iv):
(iii) Addition of sulfuric acid to the solution of the sulfonated polyaryletherketone obtained in step (ii), to obtain a reaction mixture comprising precipitated sulfonated polyaryletherketone;
(iv) Addition of water to the reaction mixture obtained in step (iii).

Steps (i) and (ii) of the process according to the present invention are already described above.

Step (iii)

The precipitation is carried out in general with sulfuric acid of 65 to 85% by weight, preferably 65 to 75% by weight, more preferably 70% by weight. The precipitation in step (iii) is carried out at a temperature of in general 0 to 40° C., preferably 0 to 30° C., more preferably 5 to 20° C. The reaction mixture obtained in step (ii) is therefore in general cooled down before sulfuric acid is added according to step (iii). The sulfuric acid is usually added slowly, e.g. dropwise or by slow continuous addition or by stepwise addition. The addition is usually carried out in 20 to 120 min, preferably 20 to 100 min, more preferably 30 to 100 min. Preferably, sulfuric acid is added until essentially no product precipitates any more.

Step (iv)

Subsequent to step (iii) in step (iv) a further treatment of the sulfonated polyaryletherketone is carried out with water, preferably DI water. Step (iv) is usually carried out at a temperature of from 0 to 50° C., preferably 10 to 40° C., more preferably 20 to 40° C. In general the water is added slowly, e.g. dropwise or by slow, continuous addition or by stepwise addition the addition of water is usually carried out in 10 to 120 min, preferably 20 to 90 min, more preferably 30 to 60 min. It was found by the inventors the a sulfonated polyaryletherketone is obtained by the two-step treatment, which is easier to handle than polyaryletherketone prepared by a process known in the art.

The sulfonated polyaryletherketone obtained is separated from the reaction mixture by a process known in the art, e.g. by filtration, decantation, or centrifugation. The product obtained is washed, preferably with hot water, and dried by methods known in the art, e.g. elevated temperature in vacuo.

The sulfonated polyaryletherketones, preferably sulfonated polyetheretherketones, obtained by the process of the present invention comprising a two-step treatment show distinctly improved swelling properties in water. Further, the sulfonated polyaryletherketones show a polydispersity index M_{w}/Mₙ of in general <2.6. M_{w} and Mₙ are determined as mentioned before. The particle size of the polyaryletherketone obtained by the process of the present invention comprising a two-step treatment is smaller than the particle size of polyaryletherketone obtained by a process known in the art.

The present invention therefore further relates to sulfonated polyaryletherketones preperable by the process of the present invention, comprising a two-step treatment. Suitable starting materials for the preparation of the sulfonated polyaryletherketones of the present invention are mentioned before.

Possible areas of application of the sulfonated polyaryletherketones of the present invention include, inter alia, the use as a polymer electrolyte membrane, with the option of employing the sulfonated polyaryletherketone, in a preferred area of application, as an ion-exchanging, preferably proton-exchanging polymer system in membranes for fuel cells.

Sulfonated polyaryletherketones of the present invention are all sulfonated polyaryletherketones mentioned before.

In a preferred embodiment, the sulfonated polyaryletherketones isolated after (ii), as described above, are dissolved in at least one suitable solvent and are cross-linked, use being made of at least one suitable cross-linking reagent.

The present application therefore further relates to a method of cross-linking sulfonated polyaryletherketones according to the present invention by reacting the sulfonated polyaryletherketones with at least one cross-linking reagent.

Preferred polyaryletherketones are mentioned above.

Examples of suitable cross-linking reagents are epoxide cross-linking agents, for example, preferably, the commercially available Denacole™.

Suitable solvents in which the cross-linking step can be carried out can be chosen, inter alia, as a function of the cross-linking reagent and the sulfonated polyaryletherketone. Preferred, inter alia, are polar aprotic solvents such as DMAc (N,N-dimethylacetamide), DMF (dimethylformamide), NMP (N-methylpyrrolidone) or mixtures thereof.

Preferably, the sulfonated polyaryletherketones prepared according to the invention having “degrees of sulfonation” in the range of from 55 to 90% are cross-linked in order thus to be suitable for use as swell-resistant and efficient fuel cell membranes.

Sulfonated polyaryletherketones having “degrees of sulfonation” in the range of less than 60%, preferably less than 55% or particularly preferably less than 50%, have, as the “degree of sulfonation” decreases, in the non-cross-linked state a controllable swelling behavior when used as fuel cell membranes. At the same time, however proton conductivity decreases. But above all, the sulfonated polyetheretherketones prepared according to the invention do, surprisingly, even at “degrees of sulfonation” of less than 50%, particularly in the range of 45% to less than 50%, as well as in the range of 35 to 40%, still exhibit excellent efficiency as a fuel cell membrane.

In a particularly preferred embodiment, the present invention describes a method of preparing a cross-linked sulfonated polyaryletherketone, preferably a polyetheretherketone, comprising the steps of
(a) Reacting the polyaryletherketone with methane sulfonic acid at temperatures in the range of from 40 to 100° C. over a time in the range of from 3 to 24 hours to obtain a sulfur-containing polyaryletherketone having a sulfur content in the range of from 8 to 15%;
(b) Reacting the sulfur-containing polyaryletherketone obtained according to (a) with oleum or highly concentrated (98% strength) sulfuric acid at temperatures in the range of from 40 to 90° C. over a time in the range of from 2 to 20 hours to obtain a sulfonated polyaryletherketone having a “degree of sulfonation” in the range of from 55 to 90%;
(c) Cross-linking the sulfonated polyaryletherketone obtained according to (b), using at least one epoxide cross-linking agent.

The present application further relates to a cross-linked sulfonated polyaryletherketone which can be prepared via the cross-linking procedure according to the invention. Preferred embodiments of the cross-linking procedure according to the invention have already been described above.

The sulfonated polyaryletherketones according to the present invention can be blended with one or more polymers. These polymers can likewise—

Like the polyaryletherketones themselves—be capable of proton exchange or generally of ion exchange. Equally it is possible, however, for polymers—optionally together with the above mentioned polymers—to be used which do not have any functional groups enabling these polymers to ion exchange. Likewise, further inorganic and/or organic compounds, which can be liquid or solid, for example, can be used together with the sulfonated polyaryletherketones or the blends of the sulfonated polyaryletherketones with the polymers.

Preferentially, at least one sulfonated polyaryletherketone is used with at least one polymer selected from polyethersulfones and polysulfones.

The present application therefore also relates to polymer blends comprising at least one sulfonated polyaryletherketone according to the present invention and further polymers, preferably at least one polyethersulfone and further inorganic and/or organic compounds if desired.

Preferentially used sulfonated polyaryletherketones have already been mentioned above. The weight ratio between the at least one sulfonated polyaryletherketone and the at least one polymer, preferably at least one polyethersulfone or polysulfone, is generally from 1:99 to 99:1, preferably from 2:1 to 20:1. The. “degree of sulfonation” of the polyaryletherketone in the polymer blends according to the invention is preferably from 45 to 80%, particularly preferably from 45 to 55% or 35 to 40%.

The inorganic and/or organic compounds used as further components generally are low molecular weight or polymeric solids, which may for example be capable of taking up protons or giving off protons.

Examples to be mentioned of these compounds which are capable of taking up protons or giving off protons are:
Phyllosilicates such as e.g. bentonites, montmorillonites, serpentine, kalinite, talc, pyrophyllite, mica. For further details, reference is made to Hollemann-Wiberg, Lehrbuch der Anorganischen Chemie [Textbook of Inorganic Chemistry], 91st to 100th edition, p. 771 et seq (2001).
Aluminosilicates such as e.g. zeolites.
Water-insoluble organic carboxylic acids such as e.g. those having from 5 to 30, preferably from 8 to 22, particularly preferably from 12 to 18 carbon atoms, having a linear or branched alkyl radical, which may or may not have one or more further functional groups, functional groups to be mentioned in particular being hydroxyl groups, C-C double bonds or carbonyl groups. The following carboxylic acids are mentioned by way of example: valeric acid, isovaleric acid, 2-methylbutteric acid, pivalic acid, caproic acid, oenanthic acid, caprylic acid, pelergonic acid, capric acid, undecaneric acid, lauric acid, tridecaneric acid, myristic acid, pentadecaneric acid, palmitic acid, mergaric acid, stearic acid, nonadecaneric acid, arachidic acid, behenic acid, lignoceric acid, cerotic acid, melissic acid, tuberculostearic acid, palmitoleic acid, oleic acid, erucic acid, sorbic acid, linolic acid, linolenic acid, elaeostearic acid, arachidonic acid, culpanodonic acid and docosahexanoic acid or mixtures of two or more of these.
Polyphosphoric acids as described, for example, in Hollemann-Wiberg, loc. cit., p. 659 et seq.
Mixtures of two or more of the above mentioned solids.

Obviously it is possible, within the scope of the present invention, for the sulfonated polyaryletherketone prepared according to the invention to be cross-linked first and then to be blended with a further compound selected from the above mentioned compounds. Equally it is conceivable for the polyaryletherketones prepared according to the invention to be put together with one or more of the above mentioned further compounds and for the resulting mixture to be cross-linked. If one or more of the further compounds is likewise to be cross-linked, cross-linking reagents can be chosen which will either inter-cross-link only the sulfonated polyaryletherketones prepared according to the invention or inter-cross-link only the further compounds or will inter-cross-link at least one of the sulfonated polyaryletherketones prepared according to the invention and at least one of the cross-linkable further compounds.

Equally, a further polymer, preferably non-functionalized, can be added. The term “non-functionalized polymer” is to be understood, within the scope of the present invention, as those polymers which are neither perfluorinated and sulfonated (ionomeric) polymers such as e.g. Nafion® or Flemion®, nor polymers functionalized with suitable groups such as e.g. —SO₃H groups or —COOH groups to obtain adequate proton conductivity. With respect to these non-functionalized polymers that can be used within the scope of the present invention, there are no particular restrictions whatsoever, as long as these are stable within the scope of the areas of application in which the polymer systems according to the invention are used. If, according to a preferred use, these are employed in fuel cells, it is necessary to use polymers which are thermally stable up to 100° C. and preferably up to 200° C. or more and which have the greatest possible chemical stability. Preferential use is made of:
Polymers having an aromatic backbone such as e.g. polyimides, polysulfones, polyethersulfones such as e.g. Ultrason®, polybenzimidazoles.
Polymers having a fluorinated backbone such as e.g. Teflon® or PVDF.
Thermoplastic polymers or copolymers such as e.g. polycarbonates such as e.g. polyethylene carbonate, polypropylene carbonate, polybutadiene carbonate or polyvinylidene carbonate or polyurethanes as described, inter alia, in WO 98/44576.
Cross-linked polyvinyl alcohols.
Vinyl polymers such as
   Polymers and copolymers of styrene or methylstyrene, vinyl chloride, acrylonitrile, methacrylonitrile, N-methylpyrrolidone, N-vinylimidazole, vinyl acetate, vinylidene fluoride.
   Copolymers of vinyl chloride and vinylidene chloride, vinyl chloride and acrylonitrile, vinylidene fluoride and hexafluoropropylene.
   Terpolymers of vinylidene fluoride and hexafluoropropylene and a compound from the group consisting of vinyl fluoride, tetrafluoroethylene and trifluoroethylene.

Such polymers are disclosed, for example, by U.S. Pat. No. 5,540,741, whose disclosure content is completely incorporated by reference into the context of the present application.
Phenol-formaldehyde resin, polytrifluorostyrene, poly(2,6-diphenyl-1,4-phenylene oxide), polyarylethersulfones, polyarylenethersulfones, phosphonated poly(2,6-dimethyl-1,4-phenylene oxide).
Homopolymers, block polymers and copolymers prepared from:
   Olefinic hydrocarbons such as e.g. ethylene, propylene, butylene, isobutene, propene, hexene or higher homologs, butadiene, cyclopentene, cyclohexene, norbornene, vinylcyclohexane.
   Acrylic acid or methacrylic acid esters such as e.g. methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl esters or tetrafluoropropyl acrylate or tetrafluoropropyl methacrylate.
   Vinyl ethers such as e.g. methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl or tetrafluoropropyl vinylether.

All of these non-functionalized polymers can in principle be used in cross-linked or non-cross-linked form.

Surprisingly it was found, within the scope of the present invention, that sulfonated polyaryletherketones prepared according to the invention, from which a blend with the above mentioned non-functionalized polymers was produced, have an extraordinarily high proton conductivity of more than 10⁻³ S/cm over wide composition ranges.

Accordingly, the present invention also relates to a polymer system as described above which comprises at least one non-functionalized polymer differing from sulfonated polyaryletherketones, preferably comprising a polyethersulfone.

While the sulfonated polyaryletherketone prepared according to the invention can in principle be employed in all suitable technical areas of application, the use as an ion-exchanging polymer system in fuel cells, e.g. as ionomer or as polymer electrolyte membrane, is particularly preferred. Here, in turn, a particularly preferred field of use to be mentioned is the use as a polymer electrolyte membrane.

Such a membrane can, in general terms, be fabricated in accordance with any suitable method from the sulfonated polyaryletherketone according to the invention, the cross-linked sulfonated polyaryletherketone according to the invention or the polymer blends according to the invention. Proton-exchanging polymer systems on the basis of sulfonated polyaryletherketones exhibit the tendency to swell, as a function of the degree of sulfonation. At higher degrees of sulfonation, the swelling characteristics adversely affect the performance of the membranes. To overcome this problem it is possible, for example, within the scope of the method according to the invention to cross-link sulfonated polyaryletherketones obtained in accordance with (ii). A suitable cross-linking procedure has already been described above.

The fabrication of the polymer electrolyte membranes is preferably effected via one of the methods listed below. To this end, a preferably homogeneous casting solution or casting dispersion is prepared from the polyaryletherketones prepared according to the invention, which may or may not be cross-linked, and from the additionally added compounds, if present, and this casting solution is applied to at least one suitable base. Equally it is possible for the resulting mixture, which can be admixed with one or more suitable diluents, to be applied to a base material by means of, for example, dipping, spin-coating, roller coating, spray coating, printing by means of relief printing, imtalgio printing, planographic printing, or screen printing procedures or alternatively by means of extrusion, should this be necessary. Further processing can be carried out in the usual manner, for example by removing the diluent and curing the materials.

Preference is given to the fabrication of membranes which generally have a thickness of from 5 to 500 μm, preferably from 10 to 500 μm and particularly preferably a thickness of from 10 to 200 μm.

The present application therefore further relates to a polymer electrolyte membrane comprising at least one sulfonated polyaryletherketone according to the invention, at least one cross-linked polyaryletherketone according to the invention or a polymer blend according to the invention. Preferred embodiments of the sulfonated polyaryletherketone, the cross-linked sulfonated polyaryletherketone, the cross-linked sulfonated polyaryletherketone and the polymer blend have already been mentioned above.

Equally, the present invention describes a composite body which comprises at least one first layer containing a sulfonated polyaryletherketone according to the invention, a cross-linked sulfonated polyaryletherketone according to the invention or a polymer blend according to the invention, also describing a composite body of this type which additionally comprises an electrically conductive catalyst layer (membrane-electrode-assembly). Furthermore, this composite body can comprise one or more bipolar electrodes.

In addition, the composite body can include one or more gas distribution layers such as e.g. a bonded carbon fiber web, between the bipolar electrode and the electrically conductive catalyst layer.

Accordingly, the present invention also relates to the use of a sulfonated polyaryletherketone according to the invention, a cross-linked sulfonated polyaryletherketone according to the invention or a polymer blend according to the invention as described above as a polymer electrolyte membrane or as ionomer, preferably as a polymer electrolyte membrane or as ionomer in a fuel cell.

The present application further relates to a fuel cell comprising at least one polymer electrolyte membrane according to the invention or a ionomer comprising a sulfonated polyaryletherketone of the present invention, a cross-linked sulfonated polyaryletherketone of the present invention, or a polymer blend of the present invention. Preferred components of the polymer electrolyte membrane and the fuel cell have already been mentioned above.

Equally, the present invention also relates to the use of at least one alkanesulfonic acid, preferably methane sulfonic acid, for treating at least one polyaryletherketone, preferably polyetheretherketone, in a method of preparing at least one polyaryletherketone, preferably sulfonated polyetheretherketone.

The invention is explained in more detail in the following examples.

### EXAMPLES

The following examples show the preparation of sulfonated polyaryletherketones having various “degrees of sulfonation”. The sulfonated polyaryletherketones obtained are used for the fabrication of three different polymer electrolyte membrane types.

### Example 1

Preparation of a Sulfonated Polyetheretherketone having a Degree of Sulfonation between 50 and 52%

300 g of polyetheretherketone (VICTREX® PEEK™ 450 P) were dissolved and reacted overnight, with stirring, at 45° C. in 5700 g of methane sulfonic acid (solution 1).

A sample of this solution 1 was transferred into DI water (DI=deionized), and the precipitated polymer was then washed and dried. A sulfur-containing PEEK having a S content of 1.2% was found. Determination of the sulfur content was performed by means of elemental analysis, to an accuracy of +/−0.2%.

832 g of oleum (25% SO₃) were then stirred into solution 1, the further reaction being carried out at 45° C. and the reaction time being 4 h 15 min (solution 2).

From the solution 2 thus obtained, sulfonated PEEK was obtained by precipitation in ice water, followed by washing with DI water and drying at 50° C. (48 h/water jet pump vacuum). Depending on the height of dropwise addition, the sulfur-containing PEEK was developed in the form of needles, fibers, granules or powder. The determination of the sulfur content was performed by means of elemental analysis, giving a value of 5% sulfur, corresponding to a calculated degree of sulfonation of 51.4%.

### Example 2

Fabrication of a Membrane from the Polyetheretherketone Sulfonated in Accordance with Example 1

18 g of the powder obtained in accordance with Example 1 and 1.8 g of Ultrason® E6020 P were dissolved in 112 g of N,N-dimethylacetamide at 150° C. and were filtered. A clear solution of sulfonated polyetheretherketone and polyethersulfone in N,N-dimethylacetamide was obtained. The casting solution, while still hot, was applied to a base material (PET sheet), a uniform layer thickness was established by means of a ductor knife, followed by flashing off for three hours at 40° C. Then the membrane was post-dried for another 16 h at 50° C. under vacuum (water jet pump).

After activation in one molar sulfuric acid (2 hours/80° C.) and post treatment using DI water (1 hour/80° C.) a membrane was obtained which, by means of impedance measurement, had a specific conductivity of at least 1·10⁻³ S/cm.

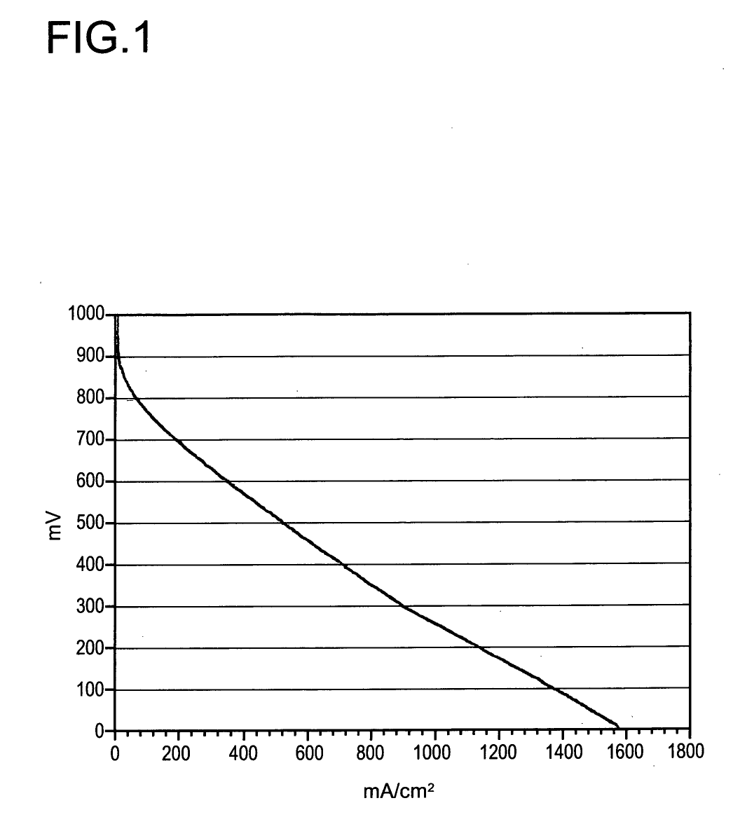

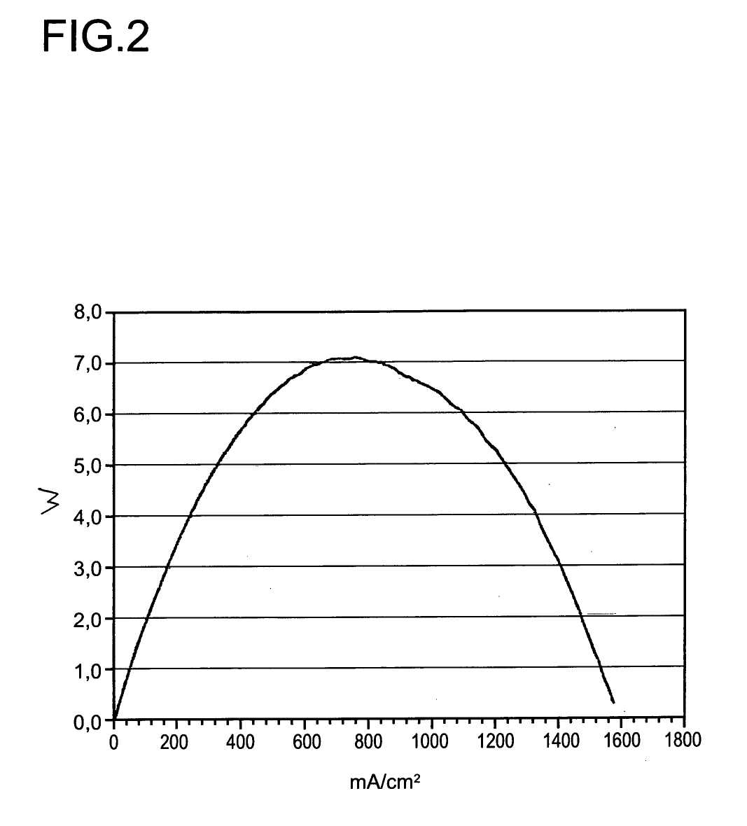

This membrane showed good performance, in laboratory fuel cells, in terms of current density/voltage (FIG. 1) and current density/output (FIG. 2).

### Example 3

Preparation of a Sulfonated Polyetheretherketone having a Degree of Sulfonation from 45 to 47%

7.5 g of polyetheretherketone (VICTREX® PEEK™ 150 P) were dissolved and reacted over a period of three hours, with stirring, at 40° C. in 142.5 g of methane sulfonic acid. After the addition of 25 g of oleum (25% SO₃) stirring was continued for a further 3.5 hours at 40° C. Then the solution was transferred into DI water, the precipitated polymer was turraxed, filtered off and washed with DI water until a pH of 4 was achieved. After overnight drying at 50° C. under vacuum (water jet pump) a sulfur content of 4.5% was found by means of elemental analysis for the polyetheretherketone thus sulfonated, corresponding to a calculated degree of sulfonation of 45.6%.

### Example 4

Fabrication of a Membrane from the Polyetheretherketone Sulfonated in Accordance with Example 3

7.5 g of the powder obtained in accordance with Example 3 were dissolved in 42.5 g of N,N-dimethylacetamide at 150° C. and were filtered. A clear solution of sulfonated polyetheretherketone in N,N-dimethylacetamide was obtained. The hot solution was cast, by means of a ductor knife, in a uniform layer thickness onto a base material (e.g. PET sheet) and was flashed off for three hours at 40° C.

After overnight drying at 50° C. under vacuum (water jet pump), the membrane was peeled off from the base sheet and treated for two hours at 80° C. with one molar sulfuric acid. After rinsing with DI water a fuel cell test was carried out.

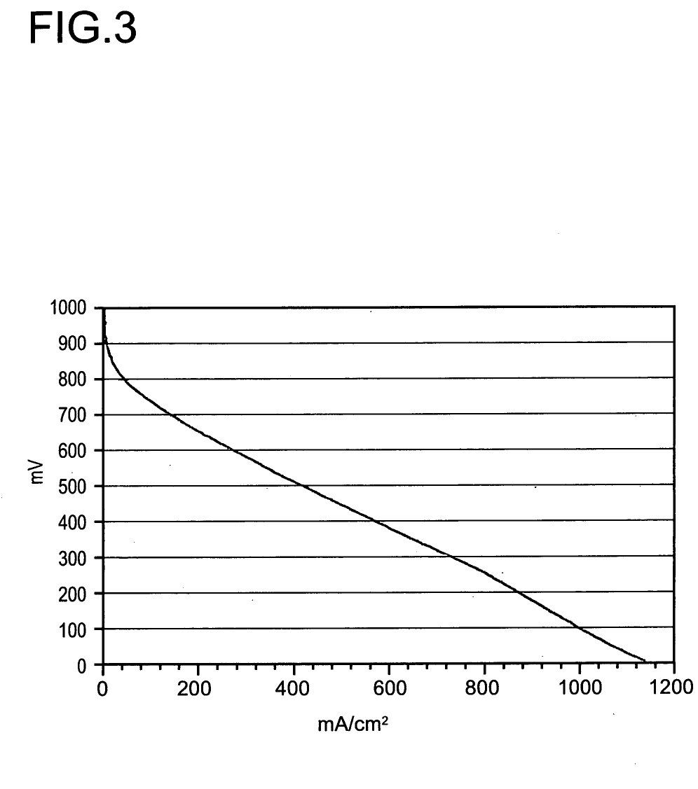

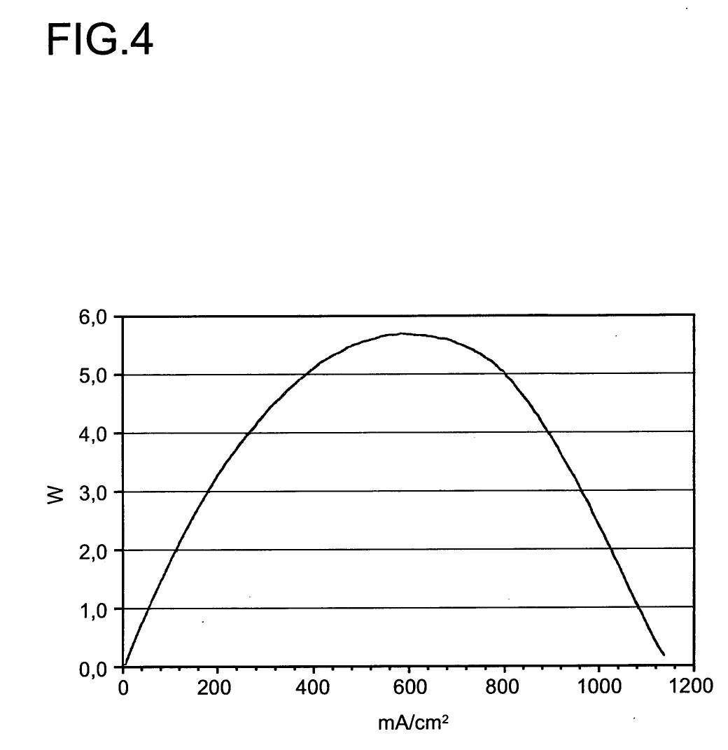

The performance in terms of current density/voltage and current density/output can be seen in FIGS. 3 and 4.

### Example 5

Preparation of a Sulfonated Polyetheretherketone having a Degree of Sulfonation from 54 to 56%

50 g of polyetheretherketone (VICTREX® PEEK™ 450 P) were dissolved and reacted over a period of four hours, with stirring, at 40° C. in 950 g of methane sulfonic acid. After the addition of 127 g of oleum (25% SO₃) stirring was continued for a further 20 hours at 40° C. Then the solution was transferred into DI water, the precipitated polymer was turraxed, filtered off and washed with DI water until a pH of 4 was achieved. After overnight drying at 50° C. under vacuum (water jet pump) a sulfur content of 5.3% was found by means of elemental analysis for the polyetheretherketone thus sulfonated, corresponding to a calculated degree of sulfonation of 54.9%.

### Example 6

Fabrication of a Membrane from the Polyetheretherketone Sulfonated in Accordance with Example 5

5.25 g of the powder obtained in accordance with Example 5 were dissolved in 79.75 g of N,N-dimethylacetamide at 105° C. and were filtered. A clear solution of sulfonated polyetheretherketone in N,N-dimethylacetamide was obtained. This solution was admixed with a bifunctional epoxide (DENACOL® EX-313), followed by stirring until the solution is homogeneous. The hot solution was cast, by means of a ductor knife, in a uniform layer thickness onto a base material (e.g.

PET sheet) and was flashed off for three hours at 40° C. After overnight drying at 50° C. under vacuum (water jet pump), the membrane was peeled off from the base sheet and treated for two hours at 80° C. with one molar sulfuric acid. After rinsing with DI water a fuel cell test was carried out.

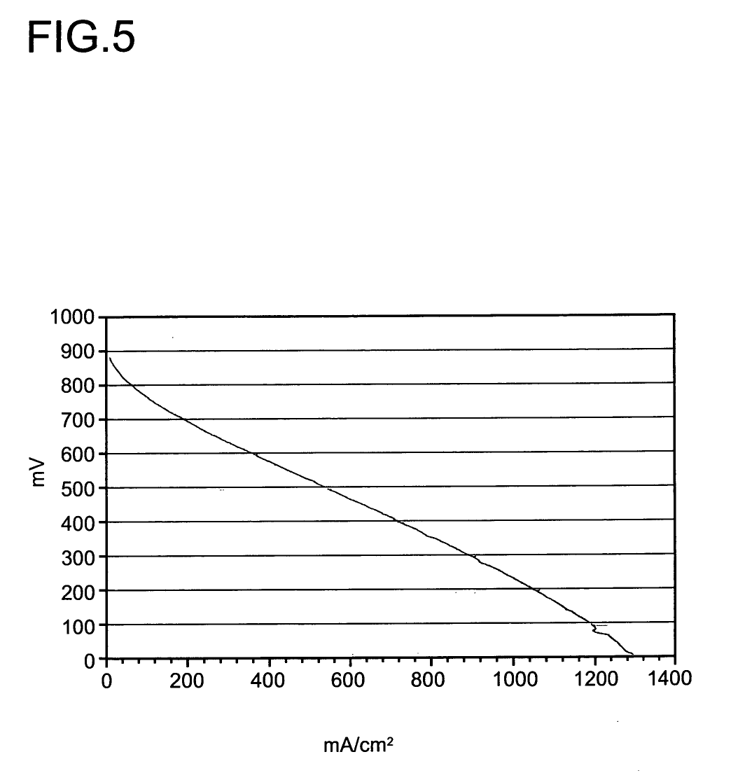

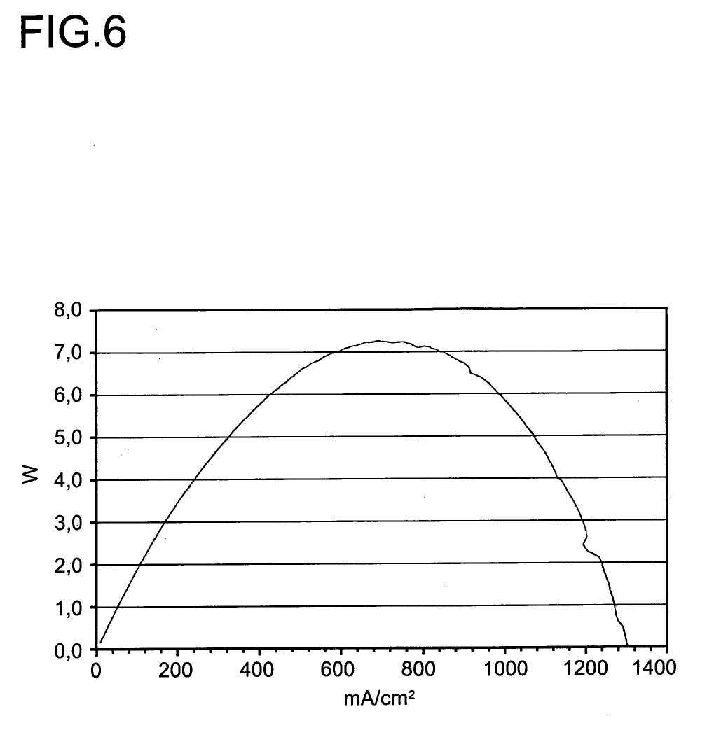

The performance in terms of current density/voltage and current density/output can be seen in FIGS. 5 and 6.

In FIGS. 1, 3 and 5, the abscissa (x-axis) shows the current density in mA/cm², and the ordinate (y-axis) shows the voltage (U) in mV.

In FIGS. 2, 4 and 6, the abscissa (x-axis) shows the current density in mA/cm², and the ordinate (y-axis) shows the output in W.

### Example 7

Preparation of a Sulfonated Polyetheretherketone having a Degree of Sulfonation between 52 and 54%.

200 g of polyetheretherketone (VICTREX® PEEK™ 450 P) were dissolved and reacted for 16 h, with stirring, at 32° C. in 3800 g of methane sulfonic acid (solution 1).

643.77 g of oleum (25% SO₃) were then stirred into solution 1, the further reaction being carried out at 40° C. and the reaction time being 220 min (solution 2).

The solution 2 thus obtained was cooled with ice water to 20° C. and “precipitation-solution”1 comprising 1719.92 g of sulfuric acid (70% by weight) was added dropwise over 90 min, at a temperature of the reaction mixture of <20° C.

Subsequently “precipitation-solution” 2 comprising 985.04 g DI water was added dropwise over 45 min, at a temperature of <40° C. The precipitated product was separated and washed with hot DI water to a pH-value of 5. After drying by 80° C. (12 h/water jet pump vacuum) the sulfonated polyetheretherketone was obtained as a powder. The determination of the sulfur content was performed by means of elemental analysis, giving a value of 5.1% sulfur, corresponding to a calculated degree of sulfonation of 52.6%.

1. A method of preparing sulfonated polyaryletherketones, comprising:
(i) reacting the at least one polyaryletherketone with at least one alkanesulfonic acid to obtain sulfur-containing polyaryletherketones (I),
wherein the reaction in accordance with (i) is carried out at temperatures in the range of 30 to 50° C.

2. The method as claimed in claim 1, wherein the alkanesulfonic acid is methane sulfonic acid, or the at least one polyaryletherketone is a polyetheretherketone, or a combination thereof.

3. The method as claimed in claim 1, wherein the reaction is carried out using at the least one alkanesulfonic acid in accordance with (i) over a period of from 2 to 20 hours.

4. The method as claimed in any one claim 1, which further comprises the additional step (ii):
(ii) reacting the sulfur comprising polyaryletherketones obtained according to (i) with at least one sulfonating agent to obtain sulfonated polyaryletherketones (II).

5. The method as claimed in claim 4, wherein the sulfonating agent used is oleum or highly concentrated (98% strength) sulfuric acid.

6. Sulfur comprising polyaryletherketones prepared in accordance with the method of claim 1.

7. Sulfonated polyaryletherketones prepared in accordance with the method of claim 4.

8. A method of preparing sulfonated polyaryletherketones comprising:
(i) reacting the at least one polyaryletherketone with at least one alkanesulfonic acid to obtain sulfur comprising polyaryletherketones (I); and
(ii) reacting the sulfur comprising polyaryletherketones obtained according to (i) with at least one sulfonating agent to obtain sulfonated polyaryletherketones (II),
wherein the sulfonated polyaryletherketones (II) are obtained in solution and are isolated from the solution by a two-step treatment comprising steps (iii) and (iv):
(iii) addition of sulfuric acid to the solution of the sulfonated polyaryletherketone obtained in (ii), to obtain a reaction mixture comprising precipitated sulfonated polyaryletherketone; and
(iv) addition of water to the reaction mixture obtained in (iii).

9. Sulfonated polyaryletherketones prepared in accordance with the method as claimed in claim 8.

10. A method of cross-linking the sulfonated polyaryletherketones of claim 7 comprising reacting the sulfonated polyaryletherketones with at least one cross-linking reagent.

11. A cross-linked sulfonated polyaryletherketone prepared in accordance with a method as claimed in claim 11.

12. Polymer blends comprising at least one sulfonated polyaryletherketone as claimed in claim 7 and at least one further polymer.

13. A polymer electrolyte membrane comprising at least one sulfonated polyaryletherketone as claimed in claim 7 and at least one cross-linked sulfonated polyaryletherketone.

14-16. (canceled)

17. A fuel cell comprising at least one polymer electrolyte membrane as claimed in claim 13.

18. A method of cross-linking sulfonated polyaryletherketones as claimed in claim 9 comprising
cross-linking the sulfonated polyaryletherketones with at least one cross-linking reagent.

19. Polymer blends comprising at least one sulfonated polyaryletherketone as claimed in claim 9 and at least one further polymer.

20. A polymer electrolyte membrane comprising at least one sulfonated polyaryletherketone as claimed in claim 9.

21. A fuel cell comprising at least one polymer electrolyte membrane as claimed in claim 20.

22. A polymer electrolyte membrane comprising a polymer blend as claimed in claim 12.

23. A polymer electrolyte membrane comprising a polymer blend as claimed in claim 19.
